(19) United States
(12) Patent Application Publication
(10) Pub. No.: US 2018/0041447 A1
(43) Pub. Date: Feb. 8, 2018

(54) SYSTEM FOR RESOURCE ALLOCATION AT TIME OF USE AND CONSERVATION OF UNUSED PORTION

(71) Applicant: BANK OF AMERICA CORPORATION, CHARLOTTE, NC (US)

(72) Inventors: Katherine Dintenfass, Lincoln, RI (US); Alicia C. Jones-McFadden, Fort Mill, SC (US); Matthew Hsieh, Charlotte, NC (US)

(21) Appl. No.: 15/231,337

(22) Filed: Aug. 8, 2016

(51) Int. Cl. H04L 12/923; H04L 12/26; H04L 29/08

(52) U.S. Cl. CPC H04L 47/762; H04L 67/10; H04L 43/0876

(57) ABSTRACT

Systems, computer program products, and methods are described herein for resource allocation at time of use and conservation of unused portion across a dispersed Internet protocol capable network connecting one or more computing devices connected to the dispersed network. The present invention is configured to provide an resource monitoring application for installation on a computing device associated with a user; retrieve information associated with a resource allocation profile associated with the user; continuously monitor the resource allocation profile of the user; determine one or more unused portions associated with the resource allocation profile based on at least continuously monitoring the resource utilization profile of the user; generate a recommendation alert, wherein the recommendation alert comprises a recommendation to reallocate the one or more unused portions to one or more alternate processes; transmit the generated recommendation alert to the computing device associated with the user.

### BACKGROUND

Resource management is the efficient and effective development of an organization's resources. Most organizations strive to achieve maximum utilization of the resources weighted by important metrics and subject to predefined constraints at the smallest level of operation. However, allocation of these resources based on these constraints and metrics may post the challenge to any organization. There is a need for a system to allocate resources at time of use and conserving unused portion of the resources for alternate processes.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for resource allocation at time of use and conservation of unused portion across a dispersed Internet protocol capable network connecting one or more computing devices connected to the dispersed network is presented. The system comprises at least one memory; at least one processing device operatively coupled to the memory device, wherein the processing device is configured to execute computer-readable program code to: provide an resource monitoring application for installation on a computing device associated with a user; retrieve information associated with a resource allocation profile associated with the user; continuously monitor the resource allocation profile of the user; determine one or more unused portions associated with the resource allocation profile based on at least continuously monitoring the resource utilization profile of the user; generate a recommendation alert, wherein the recommendation alert comprises a recommendation to reallocate the one or more unused portions to one or more alternate processes; transmit the generated recommendation alert to the computing device associated with the user.

In some embodiments, the module is further configured to: initiate a presentation of a recommendation interface for display on the computing device of the user, wherein the recommendation interface comprises the one or more alternate processes; receive, via the recommendation interface, a user selection of at least one of the one or more alternate processes for the reallocation of the one or more unused portions; and initiate a reallocation protocol configured to dynamically reallocate the one or more unused portions to the at least one of the one or more alternate processes selected by the user.

In some embodiments, the module is further configured to: determine the one or more alternate processes based on continuously monitoring a utilization capacity of each of the one or more resources associated with the resource utilization profile.

In some embodiments, the module is further configured to: determine one or more conditions associated with the utilization capacity of each of the one or more resources, wherein satisfying the one or more conditions determine the applicability of the one or more unused portions to the one or more alternate processes.

In some embodiments, the recommendation alert activates the resource monitoring application to cause the recommendation alert to display on the computing device and to enable the computing device to connect to the dispersed network.

In some embodiments, the module is further configured to: dynamically reallocate automatically, the one or more unused portions to the one or more alternate processes based on at least continuously monitor the resourcing allocation profile of the user and determining the one or more unused portions associated with the resource allocation profile.

In some embodiments, the module is further configured to: determine one or more additional resources allocated to the resource utilization profile of the user; determine at least one of the one or more alternate processes for allocation of the one or more additional resources; and dynamically reallocate the one or more additional resources to the at least one of the one or more alternate processes.

In some embodiments, the module is further configured to: initiate a presentation of a user interface for display on the computing device, wherein the user interface comprises the one or more additional resources allocated to the resource utilization profile and the one or more alternate processes; receive, via the user interface, a user selection of at least one of the one or more additional resources and at least one of the one or more alternate processes; and dynamically reallocate the at least one of the one or more additional resources to the at least one of the one or more alternate processes based on the user selection.

In some embodiments, the module is further configured to: dynamically reallocate automatically, the one or more additional resources to the at least one of the one or more alternate processes.

In another aspect, a computerized method for resource allocation at time of use and conservation of unused portion across a dispersed Internet protocol capable network connecting one or more computing devices connected to the dispersed network is presented. The method comprises providing, using a computing device processor, an resource monitoring application for installation on a computing device associated with a user; retrieving, using a computing device processor, information associated with a resource allocation profile associated with the user, wherein the information comprises information associated with one or more resources allocated to the user; continuously monitoring, using a computing device processor, the resource allocation profile of the user; determining, using a computing device processor, one or more unused portions associated with the resource allocation profile based on at least continuously monitoring the resource utilization profile of the user; generating, using a computing device processor, a recommendation alert, wherein the recommendation alert comprises a recommendation to reallocate the one or more unused portions to one or more alternate processes; transmitting, using a computing device processor, the generated recommendation alert to the computing device associated with the user.

In yet another aspect, a computer program product for resource allocation at time of use and conservation of unused portion across a dispersed Internet protocol capable network connecting one or more computing devices connected to the dispersed network is presented. The computer program product comprising a non-transitory computer-readable medium comprising code causing a first apparatus to: provide an resource monitoring application for installation on a computing device associated with a user; retrieve information associated with a resource allocation profile associated with the user, wherein the information comprises information associated with one or more resources allocated to the user; continuously monitor the resource allocation profile of the user; determine one or more unused portions associated with the resource allocation profile based on at least continuously monitoring the resource utilization profile of the user; generate a recommendation alert, wherein the recommendation alert comprises a recommendation to reallocate the one or more unused portions to one or more alternate processes; transmit the generated recommendation alert to the computing device associated with the user.

### BRIEF DESCRIPTION OF THE DRAWINGS

Having thus described embodiments of the invention in general terms, reference will now be made to the accompanying drawings, where:

FIG. 1 illustrates system environment for resource allocation at time of use and conservation of unused portion, in accordance with one embodiment of the present invention;

FIG. 2 provides a process flow for resource allocation at time of use and conservation of unused portion, in accordance with one embodiment of the present invention;

FIG. 3 provides a process flow for dynamically reallocating unused portions to an alternate process, in accordance with an embodiment of the invention; and

FIG. 4 provides a process flow for dynamically reallocating additional resources to an alternate process, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. For clarity, non-essential elements may have been omitted from some of the drawing.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

As used herein, the term “resource” will generally refer to objects, products, goods, commodities, services, and the like, and/or the ability and opportunity to view, access and use the same. Some example implementations herein contemplate property held by a user, including property that is stored and/or maintained by a third party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. Examples of resources that may not necessarily be associated with accounts may be particularized goods, such as distinct pieces of furniture, equipment, or other valuables, or the like. Similarly, “funds” or “available balance” refer to types of resources. For example, the term “fund” may be used to refer to one or more sets of monetary resources available to a user, and may also be referred to as an available balance, a collected balance, good funds, and usable funds.

In accordance with embodiments of the invention, the terms “financial institution” and “financial entity” or “entity” may include any organization that processes financial transactions including, but not limited to, banks, credit unions, savings and loan associations, investment companies, stock brokerages, asset management firms, insurance companies and the like.

Many of the example embodiments and implementations described herein contemplate interactions engaged in by a resource user with a computing device and/or one or more resource access communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, personal computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

In some example implementations, a resource access communication device is capable of interacting with a user in the sense that it can detect and parse audible statements from a user (including but not limited to spoken commands, spoken questions, and other user speech) and/or written content from a user (including but not limited to text input by a user and/or other written commands or statements), and responding to the user in the form of performing transactions, transmitting credentials, establishing communication channels, prompting the user to perform one or more actions, scheduling meetings with personnel associated with one or more resources, and the like.

Many example implementations are particularly directed to a user's interaction with resources associated with the user and stored or otherwise associated with a third party financial institution. In some such implementations, a resource access communication device, as either a stand-alone device or one integrated into a user computing device, is capable of interacting with a banking application to facilitate the efficient and effective access, monitoring, deployment, and accumulation of resources by the user. For example, a resource access communication device that is capable of detecting and processing voice commands may be used by a user to translate statements made by the user, into operative transactions, such as the satisfaction of obligations, transfers of resources, subscription to certain products and/or services, responding to offers, and the like. Similarly, a resource access communication device that is capable of detecting and processing written statements from a user, such as text messages or other written messages may likewise be used to effectuate transactions and operations associated with resources and otherwise respond to user input.

Some example implementations contemplate resource access communication devices that are able to detect, parse, and respond to predetermined command words or phrases, colloquial and/or non-specific language, and/or other natural language in a manner that allows a user to effectively monitor and manage their resource usage. For example, such a resource access communication device may be capable of recognizing a statements such as “check my transaction history”, “pay all outstanding obligations”, or other similar declarative commands, and, in response to such commands, perform the requested operation, such as providing a copy of the user's transaction history (or a portion thereof, as requested), or such as initiating transactions to pay any bills or other obligations that have not yet been paid. In another example, a resource access communication device may be able to respond to questions such as “has my paycheck been deposited”, “am I on track to retire”, “tell me about this transaction I don't recognize” by requesting and receiving the appropriate data set and/or message information, and conveying it to the user. In another example, a resource access communication device may be configured to perform operations based on other input received from the user and/or information received from one or more third parties or other sources. In one such example, a user may articulate that certain items should be added to a grocery or other shopping list, that one or more goods or services are necessary for a home or vehicle, or the like. In response to the user input, the resource access communication device may locate and/or compile offers associated with the goods, services, and/or other products associated with the statements made by the user, and convey those offers and/or other information to the user.

While some example implementations contemplate a resource access communication device and/or module that is integrated into one or more smart devices associated with the user, some example implementations contemplate one or more stand-alone resource access communication devices and/or one or more secondary communications devices. Some users may derive particularized benefits by having secondary communication devices deployed in advantageous positions around a home, workspace, or other locations, wherein such secondary communication devices are capable of communicating user input to a resource access communication device and relaying information back to the user. For example, a user may opt to position one secondary communication device in a kitchen, and recite items that may be needed for the completion of a particular recipe or a grocery list. The secondary communication device can in turn relay the information to a resource access communication device for further processing, and relay back to the user any response from the resource access communication device. Similarly, a user may opt to position a secondary communication device near where the user often processes mail or other correspondence, such that the user can provide instructions to pay bills or otherwise interact with service providers, entities associated with offers received by the user, and other entities associated with correspondence received by the user. Those skilled in the art will appreciate that a user may opt to position such secondary communication devices in any location where it may be advantageous to be able to issue speaking and/or written commands or statements to provide information about potential resource uses, initiate transactions, and/or otherwise monitor the status and use of resources.

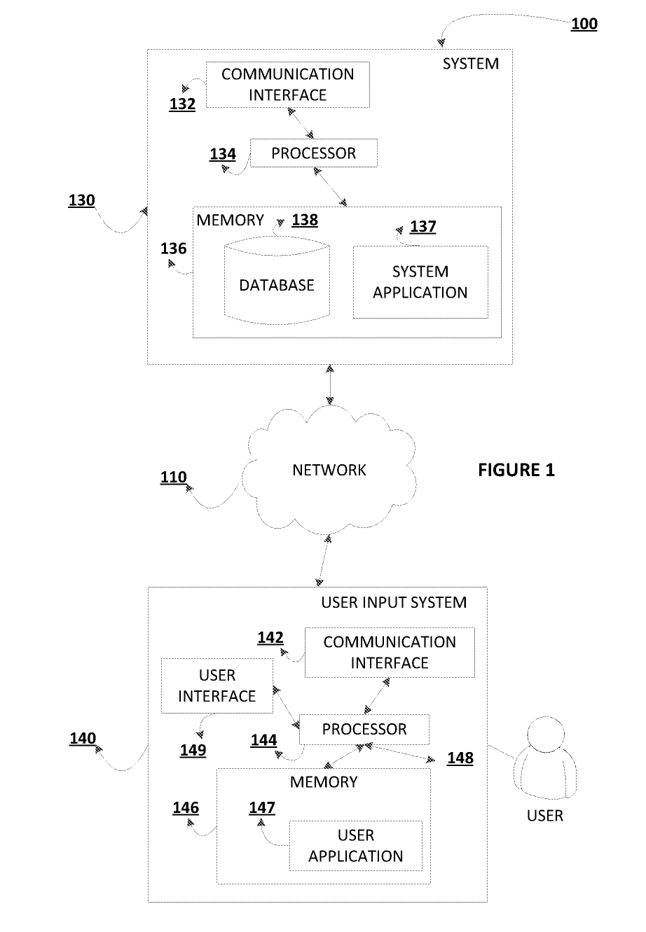

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

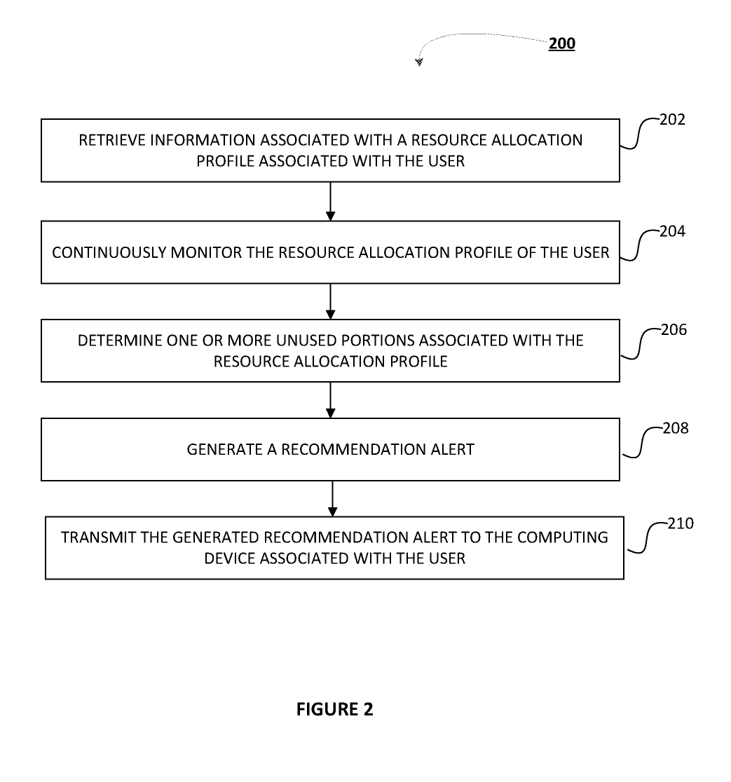

FIG. 2 provides a process flow for resource allocation at time of use and conservation of unused portion, in accordance with one embodiment of the present invention. As shown in block 202, the process flow includes retrieving information associated with a resource allocation profile associated with the user. In some embodiments, the information comprises information associated with one or more resources allocated to the user. In one aspect, the system may be configured to extract one or more characteristic traits of the user and develop a user profile to determine potential resources to be allocated to the user. In some embodiments, the user profile indicates a lifestyle of the user. In some embodiments, the one or more traits user profile may be determined based on at least one or more past transactions of the user (financial or otherwise), a geographic location of the user, an income level, an amount of outgoing funds, asset values, liability values, asset types, spending habits, saving habits or the like. In one aspect, the user profile includes at least information identifying the user. In some embodiments, the system may be configured to establish predefined user profiles including, but not limited to travel profiles, homebody, luxury spender, thrifty saver, risk taker, or the like. The profiles may be pre-programed by the entity and/or programmable by the user. In some embodiments, the system may be configured to enable the user to customize the determined user profile. In this regard, the system may be configured to enable the user to select a predetermined user profile and customize the user profile according to the characteristics of the user by providing additional information. In some embodiments, the one or more characteristic traits include but are not limited to determining an employment status, education level, one or more financial events of the user, and/or the like. In one aspect, a financial event may be a charge, a transaction, and exchange, or the like that may cause the user to lose or gain money and/or assets.

Next, as shown in block 204, the process flow includes continuously monitoring the resource allocation profile of the user. In the regard, the system may to provide a resource monitoring application for installation on a computing device associated with the user. As described herein, the one or more resources may be monitored using a resource communication device associated with the computing device of the user. For example, a resource allocated to the user may include a financial product (e.g., a student loan) provided to the user. In this regard, monitoring the resource may include monitoring the user's payments towards the financial product.

Next, as shown in block 206, the process flow includes determining one or more unused portions associated with the resource allocation profile. In doing so, the system may be configured to potentially reallocate the one or more unused portions to one or more alternate processes. For example, unused portions of the resource allocation profile may include a remainder amount associated with the user's payment plan towards the student loan. As used herein, alternate processes may refer to a project, a process, a production, a phase of production, a control, a control objective, a device, a protocol, service, or metric, or the like. In one example, an alternate process may be a credit card balance as part of a credit card account. In this way, the system may identify customers who are paying down student loans and determines an option for the customer to roll over the remainder of the student loan debt towards a credit card with zero percent interest. In some embodiments, the one or more unused portions of the allocated resources may include one or more devices (e.g., memory device) associated with the computing device of the user. By monitoring the allocated resources, the system may determine that the user does not utilize the allocated resources to maximum capacity. In response, the system may determine alternative processes that require additional resources for efficient processing and recommend reallocation of the unused portion of the allocated resources to be applied towards the alternative processes.

Next, as shown in block 208, the process flow includes generating a recommendation alert. The recommendation alert includes a recommendation to reallocate the one or more unused portions to one or more alternate processes. In some embodiments, the recommendation alert activates the resource monitoring application to cause the recommendation alert to display on the computing device and to enable the computing device to connect to the dispersed network. In one aspect, the system may provide one or more incentives associated with the reallocation to the user in the recommendation alert. Next, as shown in block 210, the process flow includes transmitting the generated recommendation alert to the computing device associated with the user.

In some embodiments, the system may be configured to determine the one or more alternate processes based on continuously monitoring a utilization capacity of each of the one or more resources associated with the resource utilization profile. In one aspect, the system may be configured to continuously monitor the utilization capacity of each of the one or more resources for a predetermined period of time. In some embodiments, the system may be configured to determine one or more conditions associated with the utilization capacity of each of the one or more resources. In one aspect, the one or more conditions may include a predetermined threshold associated with utilization capacity. In some embodiments, when the utilization capacity of each resource is below the predetermined threshold, the system may determine applicability of the one or more unused portions to the one or more alternate processes. For example, the one or more conditions being applied to the one or more resources may include an amount of funds paid back by the customer towards the student loans. If the customer has paid back 70% of the student loan and made payments regularly with minimal interruption, the system provides the customer a loyalty based flexible student loan product.

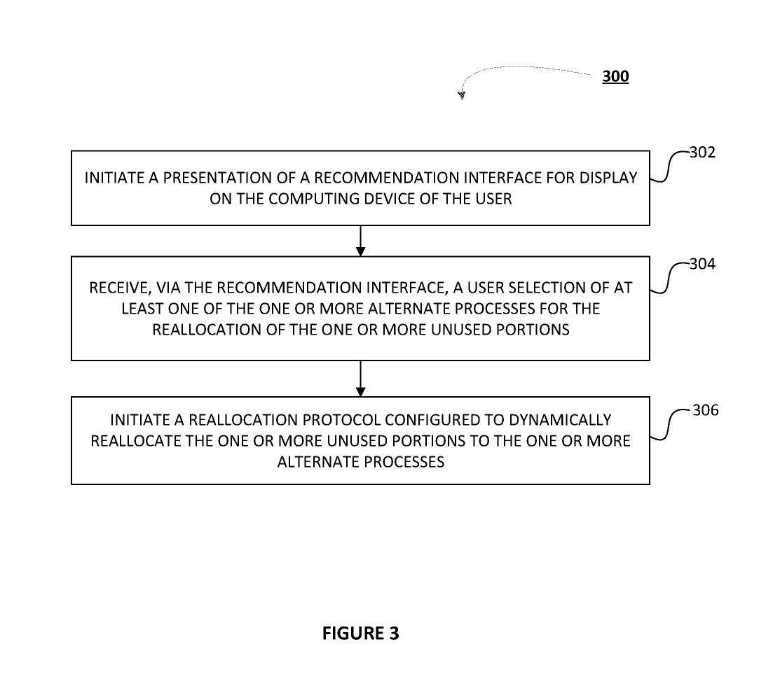

FIG. 3 provides a process flow for dynamically reallocating unused portions to an alternate process, in accordance with an embodiment of the invention. As shown in block 302, the process flow includes initiating a presentation of a recommendation interface for display on the computing device of the user. In this regard, the system may be configured to establish a communication link with the computing device of the user. In response to establishing the communication link, the system may be configured to transmit control signals configured to cause the display device of the computing device to display the recommendation alert. In some embodiments, the recommendation interface includes one or more alternate processes.

Next, as shown in block 304, the process flow includes receiving, via the recommendation interface, a user selection of at least one of the one or more alternate processes for the reallocation of the one or more unused portions. In one aspect, the one or more alternate processes may be arranged in the order of resource requirement. In another aspect, the one or more alternate processes may be arranged based on incentives associated with each alternative resource. For example, the system may incentivize the customers to invest what they would have been paying towards their student loans (or some portion thereof) towards an alternative goal or towards continuing to pay towards a credit card payment. In this way, the system may provide an incentive to the user by determining how much faster the user will be able to pay the credit card debt than they would have been able to pay down the student loan debt (having an interest rate). The user may select at least one of the one or more alternative processes to reallocate unused portions of the resources to the selected alternative processes.

Next, as shown in block 306, the process flow includes initiating a reallocation protocol configured to dynamically reallocate the one or more unused portions to the at least one of the one or more alternate processes selected by the user selected by the user. In this regard, the system may be configured dynamically reallocate automatically, the one or more unused portions to the one or more alternate processes based on at least continuously monitoring the resource allocation profile of the user and determining the one or more unused portions associated with the resource allocation profile. In one aspect, the system may be configured to receive user authorization for the reallocation of the at least one of the one or more unused portions associated with the resource allocation profile to the one or more alternate processes.

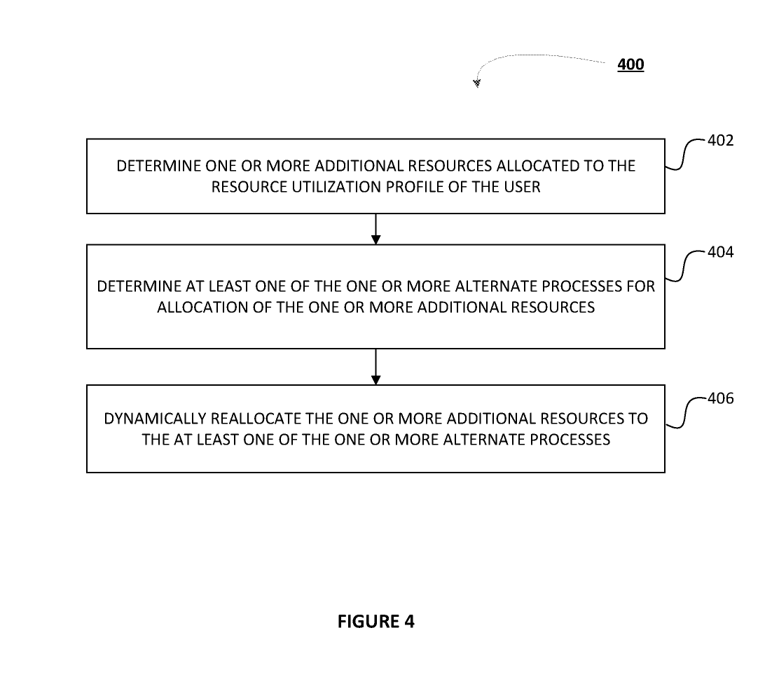

FIG. 4 provides a process flow for dynamically reallocating additional resources to an alternate process, in accordance with an embodiment of the invention. As shown in block 402, the process flow includes determining one or more additional resources allocated to the resource utilization profile of the user. In one aspect, the one or more additional resources may include, but are not limited to, additional hardware and/or software added to the resource utilization profile of the user, additional accounts that have cash or cash equivalents. For example, if the user indicates that he/she received a pay raise by his/her employer, the increment is referred to as an additional resource. Next, the system may determine at least one of the one or more alternate processes for allocation of the one or more additional resources, as shown in block 404. In response, the system may dynamically reallocate the one or more additional resources to the at least one of the one or more alternate processes, as shown in block 406. In line with the examples discussed herein, the system may be configured to dynamically adjust the payment plan of the user and enroll the user in a rewards program based on loyalty to the entity.

In some embodiments, the system may be configured to initiate a presentation of a user interface for display on the computing device, wherein the user interface comprises the one or more additional resources allocated to the resource utilization profile and the one or more alternate processes. Next, the system may be configured to receive, via the user interface, a user selection of at least one of the one or more additional resources and at least one of the one or more alternate processes. In response, the system may dynamically reallocate the at least one of the one or more additional resources to the at least one of the one or more alternate processes based on the user selection. In some embodiments, the system may dynamically reallocate automatically, the one or more additional resources to the at least one of the one or more alternate processes.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 7259US1.014033.2850 | To be assigned | RESOURCE TRACKING | Concurrently |
| | | AND UTILIZATION | herewith |
| | | SYSTEM | |
| 7261US1.014033.2851 | To be assigned | RESOURCE ASSIGNMENT | Concurrently |
| | | SYSTEM | herewith |
| 7262US1.014033.2852 | To be assigned | RESOURCE ASSIGNMENT | Concurrently |
| | | SYSTEM WITH | herewith |
| | | ALLOCATION ASSIST | |
| 7264US1.014033.2854 | To be assigned | SYSTEM FOR RESOURCE | Concurrently |
| | | ALLOCATION AND | herewith |
| | | CONSERVATION OF | |
| | | UNUSED PORTION | |
| 7265US1.014033.2855 | To be assigned | SYSTEM FOR | Concurrently |
| | | MONITORING RESOURCE | herewith |
| | | ACTIVITY AND ALERT | |
| | | GENERATION | |

What is claimed is:

1. A system for resource allocation at time of use and conservation of unused portion across a dispersed Internet protocol capable network connecting one or more computing devices connected to the dispersed network, the system comprising:
at least one memory;
at least one processing device operatively coupled to the memory device, wherein the processing device is configured to execute computer-readable program code to:
provide an resource monitoring application for installation on a computing device associated with a user;
retrieve information associated with a resource allocation profile associated with the user, wherein the information comprises information associated with one or more resources allocated to the user;
continuously monitor the resource allocation profile of the user;
determine one or more unused portions associated with the resource allocation profile based on at least continuously monitoring the resource utilization profile of the user;
generate a recommendation alert, wherein the recommendation alert comprises a recommendation to reallocate the one or more unused portions to one or more alternate processes; and
transmit the generated recommendation alert to the computing device associated with the user.

2. The system of claim 1, wherein the module is further configured to:
initiate a presentation of a recommendation interface for display on the computing device of the user, wherein the recommendation interface comprises the one or more alternate processes;
receive, via the recommendation interface, a user selection of at least one of the one or more alternate processes for the reallocation of the one or more unused portions; and
initiate a reallocation protocol configured to dynamically reallocate the one or more unused portions to the at least one of the one or more alternate processes selected by the user.

3. The system of claim 1, wherein the module is further configured to:
determine the one or more alternate processes based on continuously monitoring a utilization capacity of each of the one or more resources associated with the resource utilization profile.

4. The system of claim 3, wherein the module is further configured to:
determine one or more conditions associated with the utilization capacity of each of the one or more resources, wherein satisfying the one or more conditions determine the applicability of the one or more unused portions to the one or more alternate processes.

5. The system of claim 1, wherein the recommendation alert activates the resource monitoring application to cause the recommendation alert to display on the computing device and to enable the computing device to connect to the dispersed network.

6. The system of claim 1, wherein the module is further configured to:
dynamically reallocate automatically, the one or more unused portions to the one or more alternate processes based on at least continuously monitoring the resource allocation profile of the user and determining the one or more unused portions associated with the resource allocation profile.

7. The system of claim 1, wherein the module is further configured to:
determine one or more additional resources allocated to the resource utilization profile of the user;
determine at least one of the one or more alternate processes for allocation of the one or more additional resources; and
dynamically reallocate the one or more additional resources to the at least one of the one or more alternate processes.

8. The system of claim 7, wherein the module is further configured to:
initiate a presentation of a user interface for display on the computing device, wherein the user interface comprises the one or more additional resources allocated to the resource utilization profile and the one or more alternate processes;
receive, via the user interface, a user selection of at least one of the one or more additional resources and at least one of the one or more alternate processes; and
dynamically reallocate the at least one of the one or more additional resources to the at least one of the one or more alternate processes based on the user selection.

9. The system of claim 7, wherein the module is further configured to:
dynamically reallocate automatically, the one or more additional resources to the at least one of the one or more alternate processes.

10. A computerized method for resource allocation at time of use and conservation of unused portion across a dispersed Internet protocol capable network connecting one or more computing devices connected to the dispersed network, the method comprising:
providing, using a computing device processor, an resource monitoring application for installation on a computing device associated with a user;
retrieving, using a computing device processor, information associated with a resource allocation profile associated with the user, wherein the information comprises information associated with one or more resources allocated to the user;
continuously monitoring, using a computing device processor, the resource allocation profile of the user;
determining, using a computing device processor, one or more unused portions associated with the resource allocation profile based on at least continuously monitoring the resource utilization profile of the user;
generating, using a computing device processor, a recommendation alert, wherein the recommendation alert comprises a recommendation to reallocate the one or more unused portions to one or more alternate processes; and
transmitting, using a computing device processor, the generated recommendation alert to the computing device associated with the user.

11. The method of claim 10, wherein the method further comprises:
initiating a presentation of a recommendation interface for display on the computing device of the user, wherein the recommendation interface comprises the one or more alternate processes;
receiving, via the recommendation interface, a user selection of at least one of the one or more alternate processes for the reallocation of the one or more unused portions; and
initiating a reallocation protocol configured to dynamically reallocate the one or more unused portions to the at least one of the one or more alternate processes selected by the user.

12. The method of claim 10, wherein the method further comprises:
determining the one or more alternate processes based on continuously monitoring a utilization capacity of each of the one or more resources associated with the resource utilization profile.

13. The method of claim 12, wherein the method further comprises:
determining one or more conditions associated with the utilization capacity of each of the one or more resources, wherein satisfying the one or more conditions determine the applicability of the one or more unused portions to the one or more alternate processes.

14. The method of claim 10, wherein the recommendation alert activates the resource monitoring application to cause the recommendation alert to display on the computing device and to enable the computing device to connect to the dispersed network.

15. The method of claim 10, wherein the method further comprises:
dynamically reallocating automatically, the one or more unused portions to the one or more alternate processes based on at least continuously monitor the resource allocation profile of the user and determining the one or more unused portions associated with the resource allocation profile.

16. The method of claim 10, wherein the method further comprises:
determining one or more additional resources allocated to the resource utilization profile of the user;
determining at least one of the one or more alternate processes for allocation of the one or more additional resources; and
dynamically reallocating the one or more additional resources to the at least one of the one or more alternate processes.

17. The method of claim 16, wherein the method further comprises:
initiating a presentation of a user interface for display on the computing device, wherein the user interface comprises the one or more additional resources allocated to the resource utilization profile and the one or more alternate processes;
receiving, via the user interface, a user selection of at least one of the one or more additional resources and at least one of the one or more alternate processes; and
dynamically reallocating the at least one of the one or more additional resources to the at least one of the one or more alternate processes based on the user selection.

18. The method of claim 16, wherein the method further comprises:
dynamically reallocating automatically, the one or more additional resources to the at least one of the one or more alternate processes.

19. A computer program product for resource allocation at time of use and conservation of unused portion across a dispersed Internet protocol capable network connecting one or more computing devices connected to the dispersed network, the computer program product comprising a non-transitory computer-readable medium comprising code causing a first apparatus to:
provide an resource monitoring application for installation on a computing device associated with a user;
retrieve information associated with a resource allocation profile associated with the user, wherein the information comprises information associated with one or more resources allocated to the user;
continuously monitor the resource allocation profile of the user;
determine one or more unused portions associated with the resource allocation profile based on at least continuously monitoring the resource utilization profile of the user;
generate a recommendation alert, wherein the recommendation alert comprises a recommendation to reallocate the one or more unused portions to one or more alternate processes; and
transmit the generated recommendation alert to the computing device associated with the user.

20. The system of claim 19, wherein the first apparatus is further configured to:
initiate a presentation of a recommendation interface for display on the computing device of the user, wherein the recommendation interface comprises the one or more alternate processes;
receive, via the recommendation interface, a user selection of at least one of the one or more alternate processes for the reallocation of the one or more unused portions; and
initiate a reallocation protocol configured to dynamically reallocate the one or more unused portions to the at least one of the one or more alternate processes selected by the user.
